(19) United States
(12) Patent Application Publication
(10) Pub. No.: US 2008/0061609 A1
(43) Pub. Date: Mar. 13, 2008

(54) AIRPLANE PASSENGER SEATS WITH EMBEDDED DISPLAYS AND OTHER I/O COMPONENTS FOR INTERFACING WITH PASSENGER LAPTOP COMPUTERS

(76) Inventor: ROBERT V. WILLIAMSON, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/470,447

(22) Filed: Sep. 6, 2006

(51) Int. Cl. A47C 31/00; A47C 7/62

(52) U.S. Cl. 297/217.3

(57) ABSTRACT

A method, system, and device for interfacing with a portable electronic device such as a laptop computer on an airplane, while the laptop computer is stowed in a seat pocket. A keyboard, touch screen display, and electrical interfaces are attached to the back of each display-enabled passenger seat on an airplane, such that the passenger seated behind each enhanced passenger seat may access the keyboard, touch screen display, and electrical interfaces. Display, mouse, and keyboard data interface connections are located in each seat pocket. The electrical interfaces allow a laptop computer user to utilize the keyboard, which is preferably waterproof and embedded in a fold-down tray table attached to the back of the seat in front of the user. The electrical interfaces allow a touch screen display, which is preferably embedded in the back of the seat in front of the user, to regenerate data from the laptop computer.

### BACKGROUND OF THE INVENTION

1. Technical Field

The present invention relates in general to the field of computers and in particular to laptop computers. Still more particularly, the present invention relates to an improved method and system for interfacing with a laptop computer on an airplane.

2. Description of the Related Art

The use of laptop computers is quite common on airplanes. Conventional methods of using laptop computers on airplanes typically include placing the laptop computer on a fold-down tray attached to the back side of the passenger seat in front of the user. Some airlines currently have display screens embedded in the backs of airline passenger seats. For example, Song Airlines, a former subsidiary of Delta, had touch screen displays in each passenger seat that utilized the Linux operating system to provide flight information and entertainment functions.

The use of laptop computers on airplanes allows most business users and some non-business users to increase their productivity while traveling. However, issues may arise when conventional methods of using a laptop computer on an airplane are implemented. Conventional laptop computers typically include hinged display screens that must open upward from the keyboard in order to be viewed. If a laptop computer is placed on the fold-down tray of an airline seat and the laptop's display screen is positioned at an obtuse angle (i.e. pointing toward the back side of the seat in front of the user), then the display screen may be pushed or damaged by the seat if the passenger sitting in front of the user reclines.

If a laptop computer user is sitting in a seat between the aisle and other passengers in the same row, then the user must constantly pick up and move the laptop computer every time one of the other passengers in the same row needs to exit the row to access the aisle. Frequently moving a laptop computer is inconvenient and may also result in damage to the laptop computer if the user inadvertently drops the laptop computer. Similarly, if an airline passenger who is using a laptop computer wishes to have a drink or a meal, the user must either put away the laptop computer or place the drink/meal on the fold-down tray of a neighboring seat, thereby hassling another passenger and/or increasing the risk of damage to the laptop computer via a spill (of food or drink). The present invention thus recognizes that an improved method and system for interfacing with a laptop computer on an airplane is needed.

### SUMMARY OF THE INVENTION

Disclosed is a method, system, and device for interfacing with a portable electronic device such as a laptop computer on an airplane, while the laptop computer is stowed away in a seat pocket, via external input/output (I/O) interface devices. A keyboard, touch screen display, and electrical interfaces are attached to the back of each display-enabled passenger seat on an airplane, such that the passenger seated behind each enhanced/modified passenger seat may access the keyboard, touch screen display, and electrical interfaces. Display, mouse, Universal Serial Bus (USB), and/or serial data interface connections are located in each seat pocket. The electrical interfaces allow a laptop computer user to utilize the keyboard, which is preferably waterproof and embedded in a fold-down tray table attached to the back of the seat in front of the user. Furthermore, the electrical interfaces allow a laptop computer user to utilize a touch screen display, which is preferably embedded in the back of the seat in front of the user, to view output data from a laptop computer. The embedded keyboard and touch screen display also provide mouse functionality to manipulate data and programs running on a laptop computer. A laptop computer user may thus connect his/her laptop computer to the provided electrical interface connections thereby allowing the laptop computer to be safely and conveniently stowed in a seat pocket during operation.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level diagram of an airline passenger seat, designed with embedded input/output (I/O) components for interfacing with a laptop computer according to one embodiment of the present invention;

FIG. 2 illustrates a touch screen display or monitor embedded in an airline passenger seat, as utilized in an embodiment of the present invention;

FIG. 3 illustrates an example graphical user interface (GUI) that may be displayed on the touch screen display of FIG. 2, according to an embodiment of the present invention; and

FIG. 4 depicts a high level block diagram of the electrical connections included within an airline passenger seat connecting the I/O components to the user-provided electronic device, according to an embodiment of the present invention.

### DETAILED DESCRIPTION OF AN ILLUSTRATIVE EMBODIMENT

The present invention provides a method and system, and device product for interfacing with a portable electronic device such as a laptop computer on an airplane, while the laptop computer is stowed away in a seat pocket, via external input/output (I/O) interface devices.

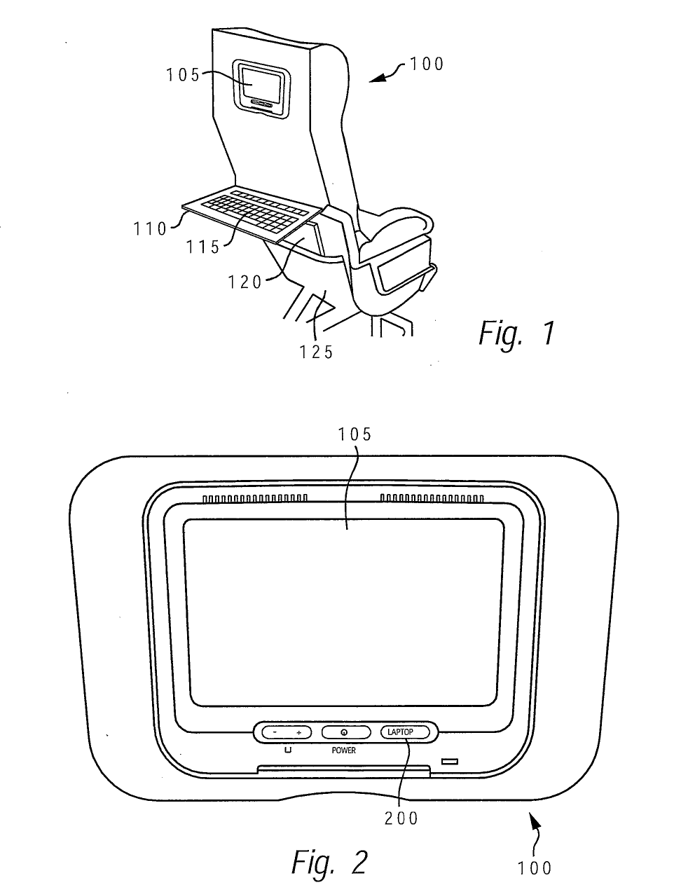

With reference now to FIG. 1, there is depicted a high level diagram of airline seat 100, designed with embedded input/output (I/O) components for interfacing with laptop computer 120, as utilized in an embodiment of the present invention. Airline seat 100 includes touch screen display 105, tray table 110, and seat pocket 125. The top of tray table 110 is configured with embedded keyboard 115, which is accessible to a passenger sitting behind airline seat 100 when tray table 110 is folded out in a horizontal position. Seat pocket 125 may also include a vent, net, grating, or other opening (not shown) to facilitate the circulation of air, thereby contributing to the cooling of laptop computer 102.

According to the illustrative embodiment, laptop computer 120 is stowed safely and conveniently within seat pocket 125, which contains display, mouse, and keyboard connections. The connections within seat pocket 125 may also include Universal Serial Bus (USB), and/or serial data connections. Laptop computer 120 may be communicatively connected to touch screen display 105 and embedded keyboard 115 via the connections in seat pocket 125, as depicted in FIG. 4, which is described in detail below. In order to prevent damage due to spills from food or drinks placed on tray table 110, embedded keyboard 115 is waterproof. Embedded keyboard 115 may be utilized to control the mouse functions of laptop computer 120. Similarly, the touch screen functionality of touch screen display 105 may also be utilized to control the mouse functions of laptop computer 120.

In an alternate embodiment, laptop computer 120 may instead be a handheld electronic device, such as a personal digital assistant (PDA), a smart phone with executable applications, an IPOD with a music selection/ordering graphical user interface (GUI), or the like. Although FIG. 1 depicts embedded keyboard 115 embedded in tray table 110, embedded keyboard 115 may instead be a separate device, such that tray table 110 need not be deployed to operate embedded keyboard 115.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

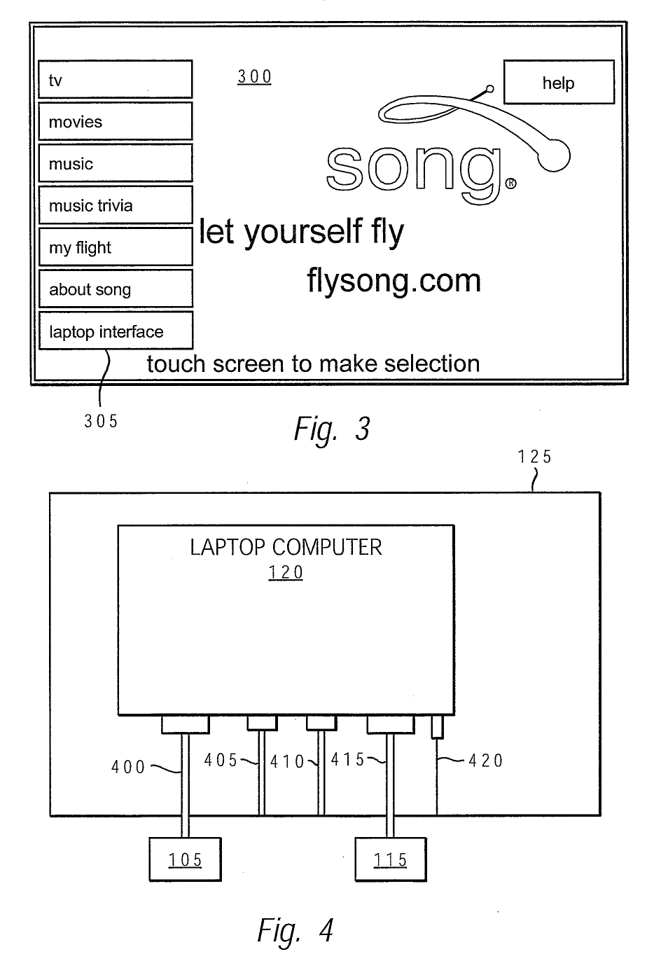

With reference now to FIG. 2, there is depicted touch screen display 105 embedded in airline seat 100, as utilized in an embodiment of the present invention. According to the illustrative embodiment, touch screen display 105 includes laptop interface button 200 and a plurality of other buttons to control various functions, such as power, contrast, and/or brightness, of touch screen display 105. A user of laptop computer 120, which is communicatively coupled to touch screen display 105, may activate or deactivate the interface between laptop computer 120 and touch screen display 105 by pressing laptop interface button 200. In an alternate embodiment, laptop interface button 200 may be implemented via the touch screen functionality of touch screen display 105 through the utilization of a graphical user interface (GUI), which is illustrated in FIG. 3 and described in detail below.

When laptop interface button 200 is pressed to initiate an interface, laptop computer 120 utilizes the connections within seat pocket 125 to communicate with an operating system (OS), such as Linux, included within touch screen display 105. If the display embedded within airline seat 100 is an embedded monitor (i.e. without an OS or touch screen functionality), laptop computer 120 may utilize hardware and/or software to communicate with the embedded monitor. The display output of laptop computer 120 is thus emulated on touch screen display 105 and the use of other I/O components, such as embedded keyboard 115, is enabled. While the interface between laptop computer 120 and the I/O components embedded within airline seat 100 is active, laptop computer 120 is turned on and is preferably stowed within seat pocket 125 with the screen/lid of laptop computer 120 in a closed/down position. When a user of laptop computer 120 has finished using laptop computer 120, he/she may then press laptop interface button 200 to terminate the interface between laptop computer 120 and the I/O components embedded within airline seat 100.

Turning now to FIG. 3, there is illustrated a GUI as provided within an embodiment of the present invention. In one embodiment, GUI 300 includes touch screen laptop interface button 305, which may be utilized to activate or deactivate the interface between laptop computer 120 and touch screen display 105, and a plurality of other graphical touch screen buttons to control various conventional functions of touch screen display 105. Touch screen laptop interface button 305 may be implemented as either a complement or replacement for laptop interface button 200. The touch screen functions of touch screen display 105 allow users of laptop computer 120 to interact with GUI 300 by using conventional mouse-like functions, such as pointing. In an alternate embodiment, touch screen display 105 may instead be a conventional output-only monitor display screen. In such an embodiment, users of laptop computer 120 could still interact with GUI 300 via embedded keyboard 115 but could also utilize an independent mouse device (e.g. a wireless mouse) connected to laptop computer 120 or embedded within tray table 110.

With reference now to FIG. 4, there is depicted a high level block diagram of the electrical connections located within seat pocket 125, as utilized in an embodiment of the present invention. Seat pocket 125 includes display connector 400, mouse connector 405, and keyboard connector 415. Seat pocket 125 also includes electrical power connector 420, which may be used to provide electrical power to laptop computer 120, and USB connector 410, which may facilitate the use of a memory stick, wireless mouse, or mouse embedded within tray table 110. In another embodiment, electrical power may be provided to laptop computer 120 via the internal battery of laptop computer 120 and seat pocket 125 thus may not include electrical power connector 420. Seat pocket 125 may also include a serial data connector to enable communication with additional peripheral devices.

Prior to pressing laptop interface button 200 or touch screen laptop interface button 305, a user of laptop computer 120 must connect display connector 400, mouse connector 405, USB connector 410, and keyboard connector 415. The present invention thus enables a user of laptop computer 120 to communicatively connect laptop computer 120 to touch screen display 105 and embedded keyboard 115 and to stow laptop computer 120 safely and conveniently in seat pocket 125 during operation.

It is understood that the use herein of specific names are for example only and not meant to imply any limitations on the invention. The invention may thus be implemented with different nomenclature/terminology and associated functionality utilized to describe the above devices/utility, etc., without limitation.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A passenger seat for use in an airplane, said seat comprising:
a vertically aligned member having a front surface and a back surface;
a display device embedded within the back surface of the vertically aligned member;
a tray table coupled to the vertically aligned member capable of rotating around an axis from (a) a first position wherein a top face of the tray table is oriented against the back surface of the vertically aligned member to (b) a second position wherein the top face is oriented in a substantially horizontal position relative to the vertically aligned member;
one or more input devices embedded within the top face of the tray table; and
connection means for coupling said display device and said one or more input devices to an electronic device provided by a passenger sitting in a seat directly behind the passenger seat to enable both input and output functionality of said electronic device via the display device and he one or more input devices.

2. The passenger seat of claim 1, wherein said display device is a touch screen display device and comprises:

3. The passenger seat of claim 1, wherein the one or more input devices comprise a keyboard.

4. The passenger seat of claim 1, wherein the connection means comprise:
a first connection cable coupled at a first end to the display device and providing a connector at a second end for connecting to a port of the electronic device;
a second connection cable coupled at a first end to the one or more input devices and providing a connector at the second end for connecting to a next port of the electronic device.

5. The passenger seat of claim 4, wherein the connector of the first and second connection cable is a USB connector.

6. The passenger seat of claim 4, wherein the connector of the first and second connection cable is a serial connector.
